(19) United States
(12) Patent Application Publication
(10) Pub. No.: US 2009/0306553 A1
(43) Pub. Date: Dec. 10, 2009

(54) Portable therapeutic support handle

(75) Inventors: Jan A. Mulholland, Brookfield, WI (US); Christine K. Cayo, Wauwatosa, WI (US)

Correspondence Address: RYAN KROMHOLZ & MANION, S.C., POST OFFICE BOX 26618, MILWAUKEE, WI, 53226, US

(73) Assignee: Assistive Resources, LLC

(21) Appl. No.: 12/455,065

(22) Filed: May 28, 2009

Related U.S. Application Data
(60) Provisional application No. 61/130,287, filed on May 29, 2008.

(51) Int. Cl. A61H 1/02

(52) U.S. Cl. 601/5

(57) ABSTRACT

An apparatus according to the present invention provides a portable, adjustable limb support mechanism for use in physiotherapy or occupational therapy. The support may be clamped to various supporting structures, and the support mechanism may be capable of being positioned throughout a substantially hemispherical field of positioning once clamped to a supporting structure. A kit according to the present invention includes one or more of a selectable support base, selectable shaft length, selectable handle size, selectable color combinations, and/or selectable support accessories. A method according to the present invention includes providing a support shaft mechanism, including a grip, having substantially hemispherical positioning, stabilizing the grip in a desired position, and positioning a limb of a person against the grip so that the person may use the grip as a point of stability to facilitate improved motor accuracy.

### RELATED APPLICATIONS

This application claims the benefit of U.S. Provisional Patent Application Ser. No. 61/130,287, filed 29 May 2008, and entitled “Portable Therapeutic Support Handle,” which is incorporated herein by reference in its entirety.

### BACKGROUND OF THE INVENTION

A device according to the present invention relates generally to supportive structures, and more particularly to a portable therapeutic support handle for use in physiotherapeutic or postural assistive applications. A method according to the present invention relates generally to physiotherapy and occupational therapy, and more particularly to a method of assisting patients in maintaining limb positioning, posture or exercising.

It is thought that lifelong physical therapy for some persons, such as those having neuro-motor disorders and moderate to severe one side or total body involvement including impairments of dystonia, athetosis, and spasticity, is critical to maintaining muscle tone and preventing dislocation of various joints. Furthermore, posture correction or maintenance as related to functional outcomes is often a desirable goal.

Various devices have heretofore been employed for the exercise and therapy of a person's limbs, and correction and/or maintenance of posture. For instance, simple weight systems and stretching apparatus have been developed for exercise purposes. Further, harnesses have been employed to maintain posture. However, there is still room for improvement in adjustable limb stabilization and for use in improving body core stability.

### SUMMARY OF THE INVENTION

An apparatus or method according to the present invention provides an improved therapeutic support handle with improved adjustable limb stabilization that may be utilized to work towards improved body core stability.

According to an embodiment of a support apparatus according to the present invention, the apparatus includes a longitudinal shaft portion formed along a shaft axis and including a first shaft end and a second shaft end. A support bracket having a clamping mechanism is operatively coupled to the first shaft end. A handle is operatively coupled to the second shaft end. The handle has a grip coupled to a handle head, where the grip is formed about a grip axis. A relative positioning of the grip axis and the shaft axis is adjustable.

According to an aspect of an embodiment of a support apparatus according to the present invention, the grip axis is rotatable around the shaft axis. In addition to or in exclusion to being rotatable around the shaft axis, the grip axis may be positioned at an angle relative to the shaft axis. The angle may be greater than or equal to zero degrees and less than or equal to ninety degrees.

According to an aspect of an embodiment of a support apparatus according to the present invention, the grip may be removably coupled to the handle head. For instance, the grip may have a threaded aperture which is adapted to engage with a threaded stud extending from the handle head.

According to an aspect of an embodiment of a support apparatus according to the present invention, the handle head may have a threaded aperture which is adapted to engage with a threaded stud extending from the longitudinal shaft second shaft end.

According to an aspect of an embodiment of a support apparatus according to the present invention, the longitudinal shaft includes a first shaft member including the first shaft end and a second shaft member including the second shaft end. The second shaft member may be disposed at least partially coaxially and in a telescoping arrangement with the first shaft member. For instance, the first shaft member may include a hollow tube, wherein at least a portion of the first shaft member is disposed circumferentially around at least a portion of the second shaft member. The longitudinal shaft portion may further include a threaded adjustment collar. The adjustment collar may be movable to a first position which allows the second shaft member to slide within the first shaft member and movable to a second position which substantially prevents the second shaft member from sliding within the first shaft member.

According to an aspect of an embodiment of a support apparatus according to the present invention, the longitudinal shaft may be provided with a discrete length locking mechanism in addition to or exclusive of the adjustment collar. The discrete length locking mechanism may include an outer throughbore diametrically formed through the first shaft member, the outer throughbore being formed along an outer throughbore axis. The discrete length locking mechanism may further include a first inner throughbore diametrically formed through the second shaft member, the first inner throughbore being formed along an inner throughbore axis. Further, a pin may be provided which is adapted to be inserted into at least a portion of the outer throughbore and at least a portion of the first inner throughbore. The pin may be coupled to the support bracket.

According to an aspect of an embodiment of a support apparatus according to the present invention, the support apparatus may further include a limb support mechanism coupled to and extending radially from the longitudinal shaft portion. The limb support mechanism may be spaced from the handle grip. The limb support mechanism may include a support pad including a formed plate and a soft resilient pad attached to the plate. The limb support mechanism may further include a first support rod and a second support rod, both of which are coupled to the plate. A first shaft collar may be adapted to releasably secure the first support rod to the longitudinal shaft portion, such as the first shaft member, and a second shaft collar may be adapted to releasably secure the second support rod to the longitudinal shaft portion, such as the second shaft member.

According to an aspect of an embodiment of a support apparatus according to the present invention including a limb support mechanism, the limb support mechanism may further include a strap, at least a portion of the strap being selectively detachably coupled to the formed plate.

According to an aspect of an embodiment of a support apparatus according to the present invention, the longitudinal shaft portion may be translatable through at least a first substantially hemispherical range of motion with respect to the clamping mechanism and the handle grip is translatable through at least a second substantially hemispherical range of motion with respect to the longitudinal shaft portion.

### BRIEF DESCRIPTION OF THE DRAWINGS

FIG. 1A is a perspective view of a first embodiment of a portable therapeutic support handle according to the present invention.

FIG. 1B is a perspective view of the embodiment of FIG. 1A, further including an optional discrete length adjustment mechanism and an optional rotation-prevention mechanism.

FIG. 2 is a first perspective view of a second embodiment of a portable therapeutic support handle according to the present invention in a first position.

FIG. 3 is a second perspective view of the second embodiment of FIG. 2 in the first position.

FIG. 4 is a third perspective view of the second embodiment of FIG. 2 in the first position.

FIG. 5 is a perspective view of the second embodiment of FIG. 2 in a second position.

FIG. 6 is a perspective view of a third embodiment of a portable therapeutic support handle according to the present invention.

FIG. 7 is a perspective view of a fourth embodiment of a portable therapeutic support handle according to the present invention.

FIG. 8 is a perspective view of a fifth embodiment of a portable therapeutic support handle according to the present invention.

FIG. 9 is a perspective view of an embodiment of a limb support strap according to the present invention.

FIG. 10 is a perspective view of a first embodiment of a support pad and associated mounting structure according to the present invention.

FIG. 11 is a perspective view of a second embodiment of a support pad and associated mounting structure according to the present invention.

FIG. 12 is a perspective view of the second embodiment of FIG. 2 in use.

FIG. 13 is a perspective view of the fourth embodiment of FIG. 7 in use.

FIG. 14 is a perspective view of the fifth embodiment of FIG. 8 in use.

FIG. 15 is a perspective view of an embodiment of an alternate support bracket according to the present invention.

FIG. 16 is a perspective view of a sixth embodiment of a portable therapeutic support handle according to the present invention in combination with a wheelchair.

FIG. 17 is a perspective view of the sixth embodiment of FIG. 16 in combination with a standing frame.

FIG. 18 is an embodiment of a therapeutic handle kit according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

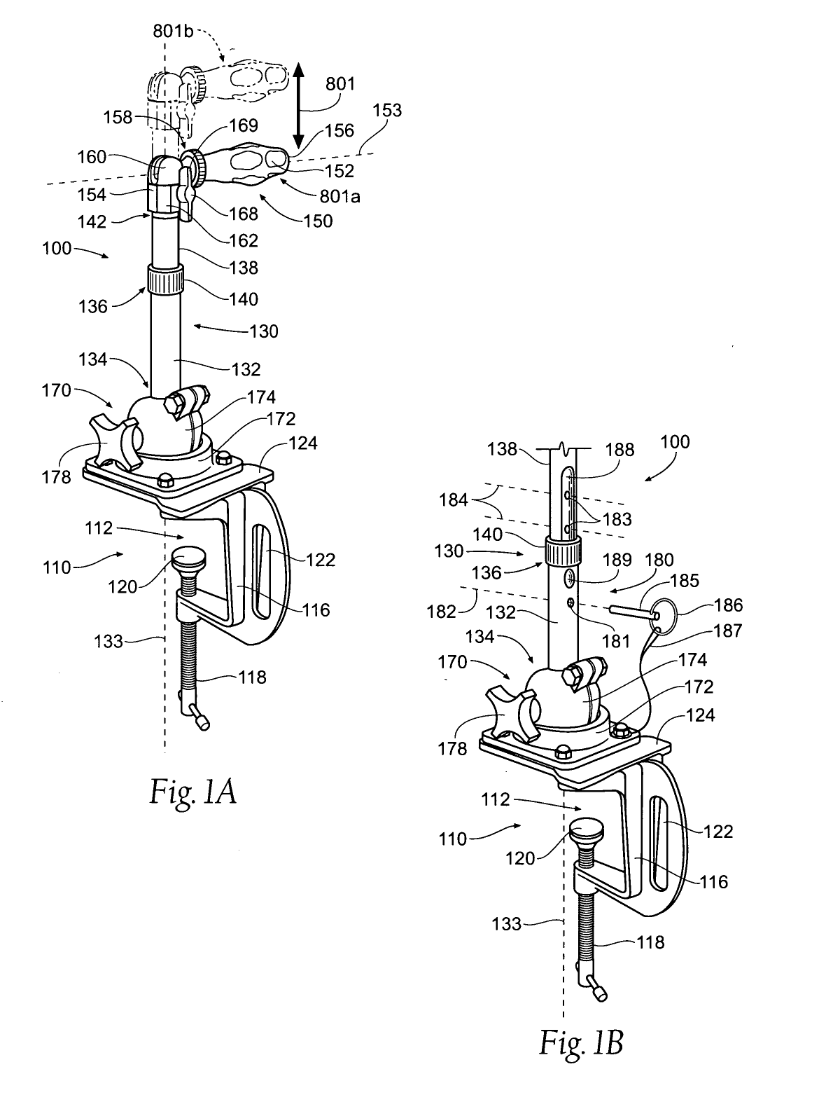

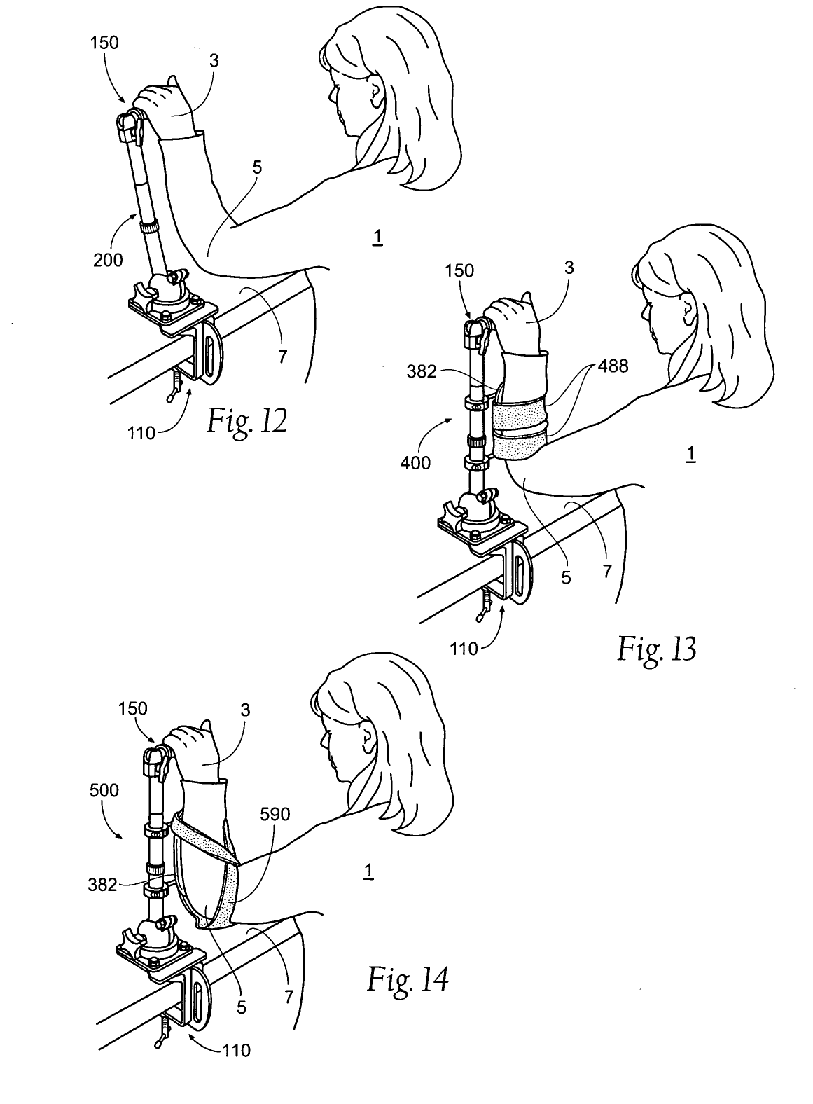

Turning now to the Figures, FIG. 1A provides a first embodiment 100 of a portable therapeutic support handle according to the present invention. Generally, the embodiment 100 includes a support bracket 110, a support shaft 130, and a handle 150. The support bracket 110 preferably includes a clamping mechanism 112 for clamping the support bracket 110 to a support structure, such as a table or desk 7, as shown in FIG. 12. The clamping mechanism 112 may be a C-clamp 114 having a clamp body 116 and a clamp engagement member 118. The clamp engagement member 118 may be provided with a protective pad 120 to assist in protecting the support structure to which the support bracket 110 is clamped. The protective pad 120 may be formed of a rubber or cork material, for example. The support bracket 110 may also include a handle 122, which may be coupled to the clamping mechanism 112, such as by being formed integrally therewith. A suitable support bracket 110 is a Panavise® Model 311 Bench Clamp Base Mount, available from Panavise Products, Inc., of Reno, Nevada. Coupled to the support bracket 110 is a support platform 124, which is preferably a substantially planar plate including mounting apertures (not shown).

The support shaft 130 generally includes a first shaft member 132 formed about a shaft axis 133. The first shaft member has a support end 134, which is coupled to the support platform 124, and a distal end 136 extending away from the support platform 124. While the handle 150 could be coupled directly to the first shaft member 132, the support shaft 130 preferably includes a second shaft member 138 disposed in a coaxial sliding relationship with the first 132. For instance, the first shaft member 132 may be a hollow shaft member into which the second shaft member 138, of smaller diameter than the first 132, is inserted. The second shaft 138 may, but preferably does not, rotate within the first shaft 132. The second shaft 138 may be provided with a longitudinal groove along at least a portion of an outside surface thereof, to engage a dimple formed on an interior surface of the first shaft 132, so as to at least substantially prevent rotation of the second shaft 138 within the first shaft 132. Such arrangement is described below with respect to FIG. 1B. The distal end 136 of the first shaft member 132 may be threaded to accept a threaded adjustment collar 140 surrounding a compression ring (not shown), which may be metal, plastic or rubber. When loosened, the threaded adjustment collar 140 allows the second shaft member 138 to slide telescopingly at least partially within the first shaft member 132, thus translating the handle 150, which is coupled to a distal end 142 of the second shaft member 138, in a first adjustment direction 144, thereby moving the entire handle 150 between a first position 801a closer to and a second position 801b further away from the support platform 124.

In addition to or alternatively to the adjustment collar 140, the shaft 130 may be provided with other adjustment or support mechanisms. For instance, as shown in FIG. 1B, the first shaft 132 and the second shaft 138 may be formed with a discrete length locking mechanism 180. The discrete length locking mechanism 180 may include an outer throughbore 181 diametrically formed through the first shaft 132 along an axis 182 and one or more inner throughbores 183 diametrically formed through the second shaft 138 along an axis 184. Where a plurality of inner throughbores 183 is provided, the respective axes 184 along which they are formed are preferably at least substantially parallel, but they may be skew. The locking mechanism 180 may further include a pin 185 that is adapted to be inserted through the outer throughbore 181 and one of the inner throughbores 183. Thus, after adjustment and insertion of the pin 185, coaxial rotation and longitudinal movement of the second shaft 138 within the first shaft 132 is at least substantially prevented. The pin 185 is preferably tethered to either the support bracket 110 or the shaft 130. The pin 185 may have a retainer ring 186 operatively coupled thereto, such as a coiled ring 186 threaded through an aperture provided through the pin. A tether strap 187, such as a plastic cord, may be operatively coupled to the ring 186 at one end and at the other end it may be secured to the support bracket 110 by a threaded fastener.

In addition or alternatively to preventing axial rotation of the second shaft 138 within the first shaft 132 after adjustment, it may be desirable to prevent coaxial rotation during adjustment. That is, with the pin 185 removed and the collar 140 loosened, it may be desirable to prevent coaxial rotation so as to maintain substantially parallel alignment of the outer throughbore axis 182 with one or more inner throughbore axis 184. One mechanism for preventing coaxial rotation of the second shaft 138 within the first shaft 132 during adjustment is by cooperating longitudinal guide slot 188 provided on one shaft 138 or 132 with a guide peg 189 disposed on the other shaft 132 or 138, respectively. The guide slot 188 is preferably provided along a length of the second shaft 138, and the guide peg 189 is preferably provided as an inwardly projecting dimple formed in the first shaft 132.

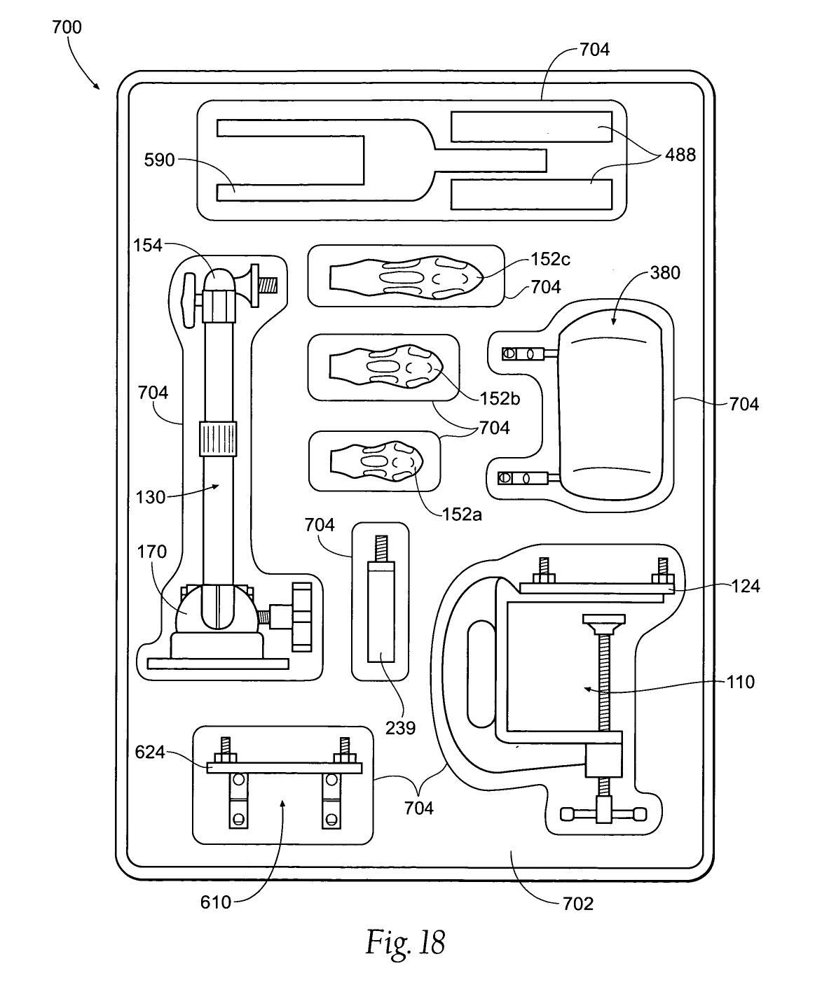

Returning to FIG. 1A, the handle 150 preferably includes a grip 152 formed about a grip axis 153. The grip 152 is coupled to a handle head 154. The grip 152 preferably includes a free end 156 oppositely disposed from a support end 158. The handle head 154 preferably includes a ball and socket adjustment mechanism 160. The ball and socket mechanism 160 may be comprised of a two-piece housing 162, which may be secured about a ball 164 and spin collar 166 by a threaded adjustment bolt 168. The threaded adjustment bolt 168 is shown as having a knob 169 to allow for quick adjustment. If a more secure adjustment is desired, the knob 169 may be eliminated and only the bolt 168, in the general form of a set screw, may be used to prevent inadvertent adjustment or to improve safety. The spin collar 166 is provided with a threaded aperture (not shown) to receive a threaded stud (not shown) extending from the first shaft member 132, the second shaft member 138, or the extension shaft 239. The grip 152 may include a threaded aperture (not shown) provided in the support end 158 that cooperates with a threaded stud (see FIG. 18) extending from the ball and socket mechanism 160. In this manner, the grip 152 may be adjusted in at least a substantially hemispherical range of motion when the threaded adjustment bolt 168 is loosened sufficiently to allow such motion. A preferred combination support shaft 130 and handle head 154 is provided-in the Model 883-T Dual Option Telescoping Mount, available from Panavise Products.

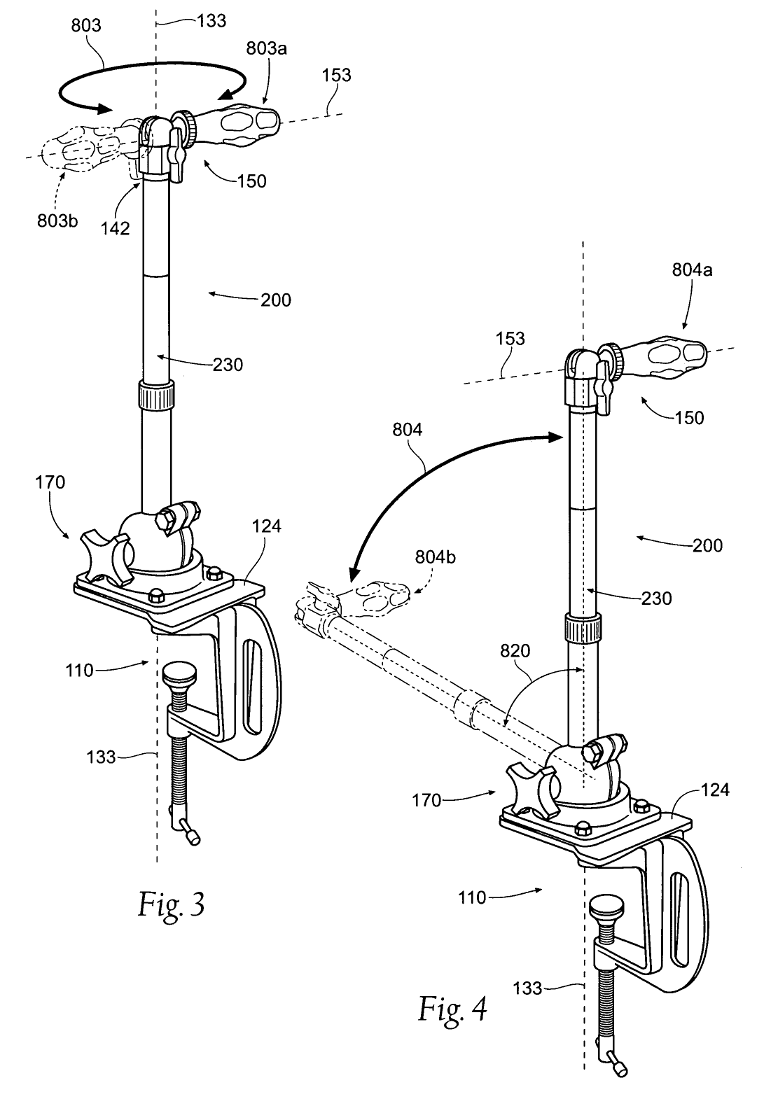

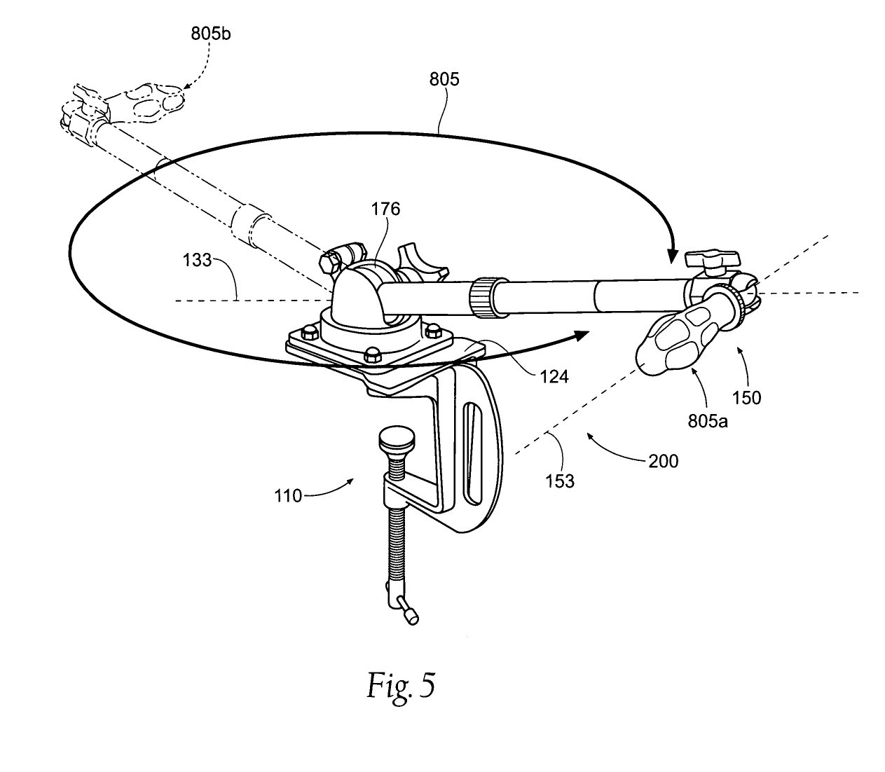

The support shaft 130 is coupled to the support platform 124. While the support shaft 130 may be coupled stationarily directly to the support platform 124, variable positioning of the shaft 130 relative to the platform 124 may be desirable. Variable positioning of the support shaft 130 relative to the platform 124 may be provided by a preferred support base 170. The support base 170 may comprise a support having three-axis adjustment and a single locking mechanism as is known, including a base housing 172, a carrier 174, and a split bushing 176 (seen in FIG. 5) situated at least partially within the carrier 174. The support base 170 is coupled to the support platform 124 and generally receives the support end 134 of the first shaft member 132 of the support shaft 130. An adjustment knob 178 is provided, which loosens the locking mechanism, thereby allowing the first shaft member 132 to spin within the bushing 176, allowing the carrier 174 to rotate within the base housing 172, and allowing the support shaft 130 to articulate as shown in FIG. 3. A preferred support base 170 that may be used is a Model 400 Heavy Duty Base, available from Panavise Products, the operation of which is described in U.S. Pat. No. 2,898,068, incorporated herein by reference in its entirety. Although the knob 178 may be provided to allow for quick and easy adjustment, a more secure positioning may be desirable. If a more secure adjustment is desired, the knob 178 may be eliminated and a bolt (not shown), in the general form of a set screw, may be used to prevent inadvertent adjustment or to improve safety.

In addition to what has been mentioned, above, regarding materials, a majority of the components comprising the clamping mechanism 110, the support shaft 130, the handle 150, and the support base 170, are formed from a material having desired strength characteristics for the expected use of the device. Materials that may be sufficient include various metals or plastic, with steel or aluminum being preferred for the majority of components. The handle grip 152 is preferably a plastic material, and any adjustment knobs, such as the top of the adjustment bolt 168 and the adjustment knob 178, may be plastic as well.

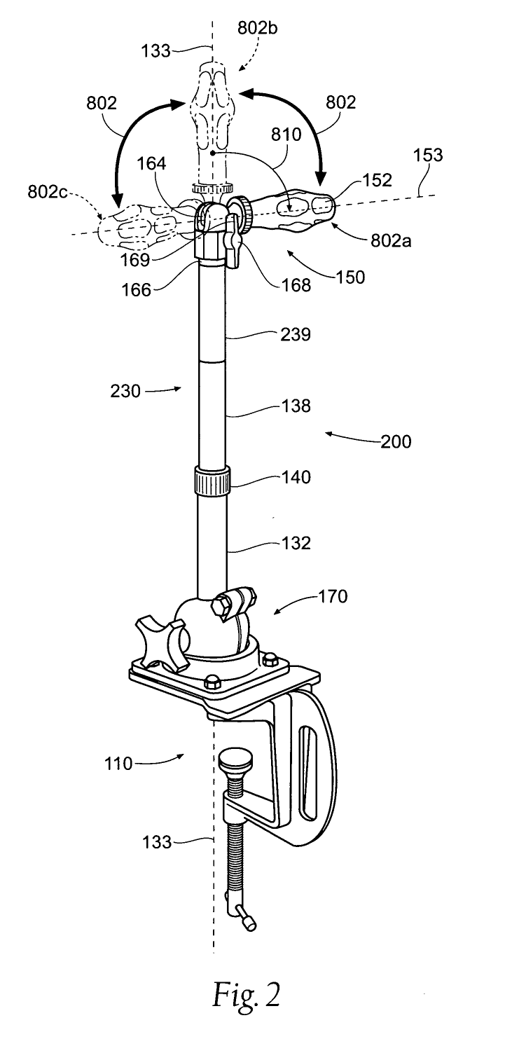

Turning now to FIG. 2, a second embodiment 200 of a portable therapeutic support handle according to the present invention is shown. Largely the same as the first embodiment 100, the second embodiment 200 includes a support shaft 230 that further includes an extension shaft 239, which may be threadably engaged with the second shaft member 138 and stationarily supported thereby. The handle 150 may then be supported by the extension shaft 239.

While the handle 150 may be fixedly coupled to the support shaft 130, or an extension 239 thereof, at a desired angle, the handle grip 152 is preferably translatable in a second direction 802 from at least a third position 802a, which is substantially perpendicular to the support shaft 130 or extension 239, to at least a fourth position 802b, which is substantially coaxial to the support shaft 130 or extension 239. The grip 152 may be further translatable along a continuation of the second direction 802 to an alternate fourth position 802c, which is substantially perpendicular to the support shaft 130 or extension 239, extending generally radially opposite from the third position 802a. The grip axis 153 may thus be positioned at a desirable angle 810, such as greater than or equal to zero degrees and less than or equal to ninety degrees with respect to the shaft axis 133.

FIG. 3 depicts a preferred translation of the handle grip 152 in a third direction 803 radially about the distal end 142 of the support shaft 230, from at least a fifth position 803a to at least an sixth position 803b. Preferably, the handle grip 152 is rotatable and positionable through a full 360 angular degrees in the third direction 803.

FIG. 4 depicts a preferred translation of the handle 150 in a fourth direction 804, from at least a seventh position 804a, in which the support shaft 230 is at least substantially perpendicular to the support platform 124, to at least a sixth position 804b, in which the support shaft 230 is at least substantially parallel to the support platform 124. The support shaft 230 is preferably positionable at any desirable position through an angle 820 of about ninety degrees.

FIG. 5 depicts a preferred translation of the handle 150 in a fifth direction 805, from at least a ninth position 805a to at least a tenth position 805b. In both positions, the support shaft 230 is depicted at the same angle relative to the support platform 124, but rotated 180 degrees in a plane parallel to the support platform 124. Thus, the translations depicted in FIG. 4 and FIG. 5 combine to provide movement of the support shaft 130 or 230 through at least a substantially hemispherical range of motion with respect to the support bracket 110.

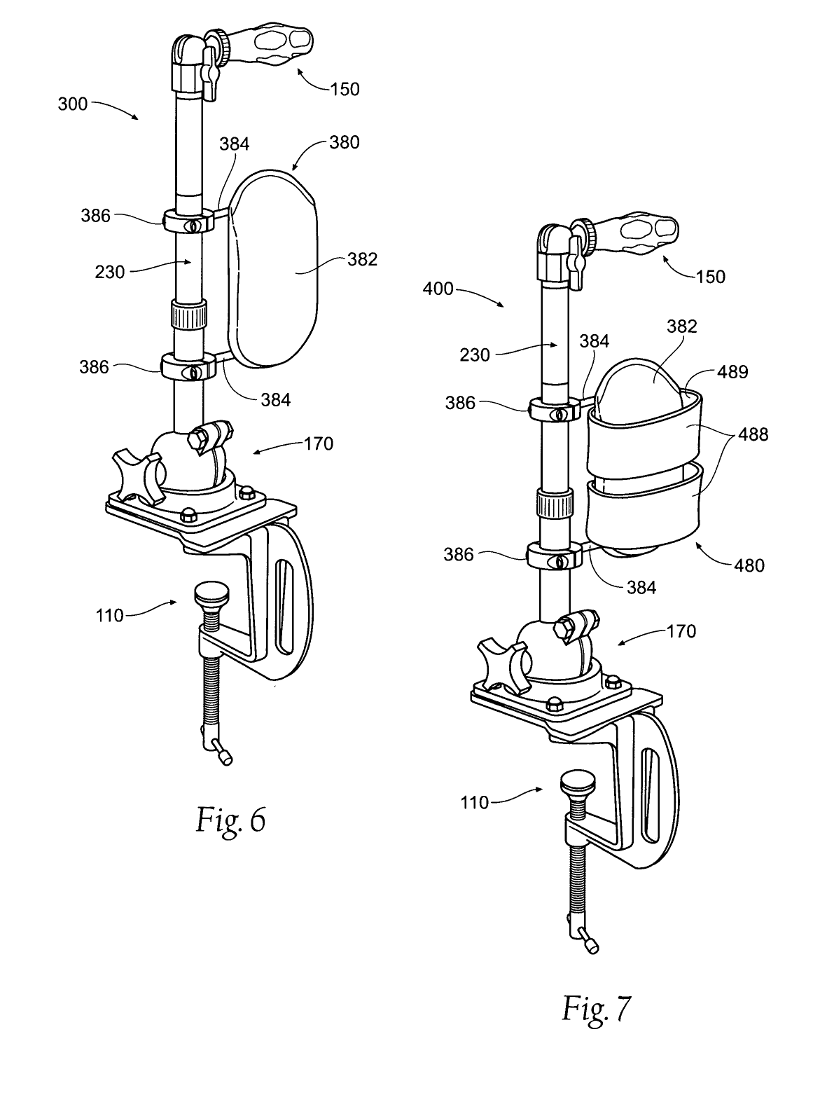

FIG. 6 provides a third embodiment 300 of a therapeutic support handle according to the present invention. Comprising generally the second embodiment 200, this embodiment 300 further includes a limb support mechanism 380. The limb support mechanism 380 generally comprises a limb support pad 382 coupled to the support shaft 230. The limb support pad 382 preferably comprises a formed plate (not shown), a soft, resilient pad (not shown), such as neoprene, disposed on a surface of the plate, and a cover material, such as leather or vinyl. Marine vinyl has been found to work sufficiently for the cover material of the limb support pad 382. The support pad 382 is supported upon the shaft 230 by at least one, but preferably a plurality of support rods 384, each being coupled to a shaft collar 386, perhaps by being threadingly engaged therewith. Disposing at least one shaft collar 386 on either side of the telescoping mechanism, such as the adjustment collar 140 of the support shaft 230, further helps to stabilize the device 300. The formed plate (not shown) may be a steel plate that is bent or otherwise machined or formed to provide a concave surface onto which the resilient pad (not shown) is placed, to be covered by the leather or vinyl covering. The support rods 384 and shaft collars 386 are preferably formed from a sturdy material, such as a metal, e.g. aluminum or steel, or a strong plastic.

FIG. 7 provides a fourth embodiment 400 of a therapeutic support handle according to the present invention. Comprising generally the third embodiment 300, this embodiment 400 further includes at least one, but preferably a plurality of a first embodiment of limb stabilizing straps 488, each strap having an engagement surface 489. The engagement surface 489 may be provided with the loop side of a hook and loop fastener, and the hook side (383 in FIGS. 10 and 11) may be disposed on the limb support pad 382. This embodiment 488 of limb stabilizing straps thus assists in maintaining a desired portion of the limb against the limb support pad 382. The stabilizing straps 488 are preferably formed from a neoprene material, as such is generally being available in a variety of colors and having desirable stretch characteristics.

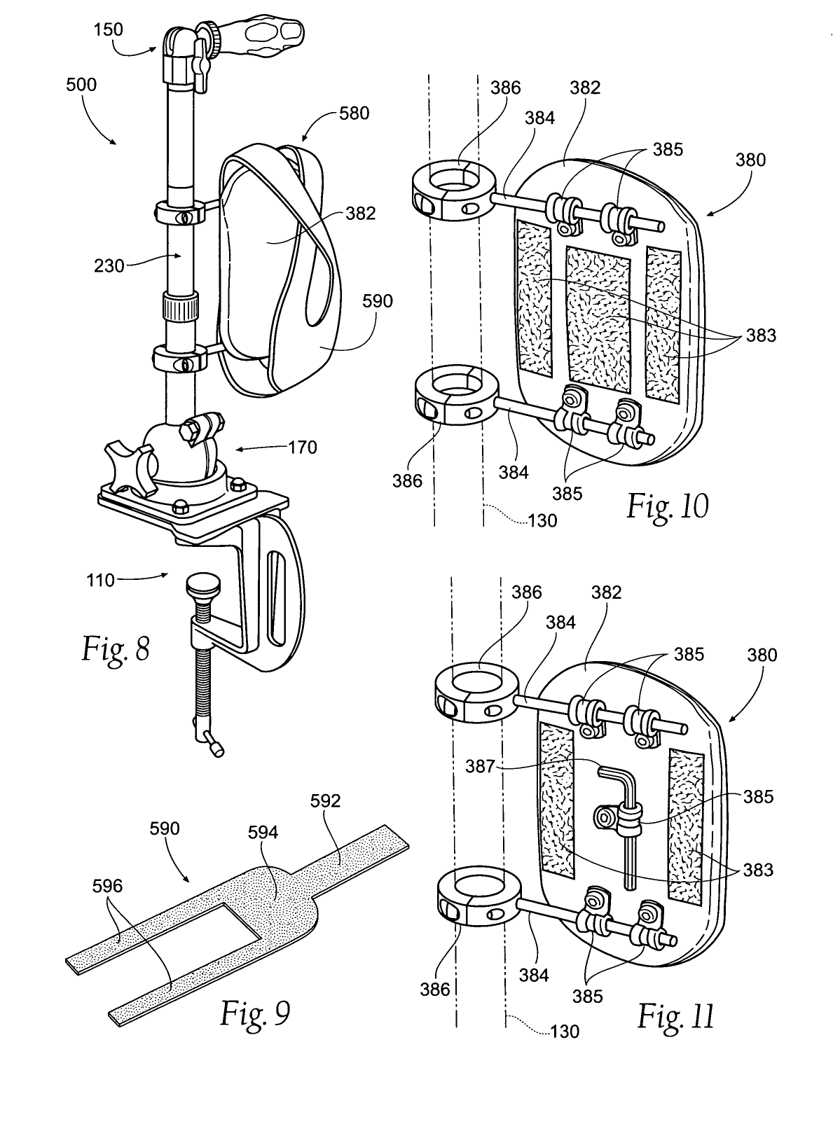

FIG. 8 provides a fifth embodiment 500 of a therapeutic support handle according to the present invention. Comprising generally the third embodiment 300, this embodiment 500 further includes a second embodiment of limb stabilizing strap 590, as is shown in FIG. 9. The second limb stabilizing strap 590 includes a support tab 592, a limb support portion 594 and two restraint tabs 596, the tabs 592,596 protruding from the limb support portion 594 in a general Y-shaped configuration. This embodiment 590 of a limb stabilizing strap thus provides limitation not only against movement away from the limb support pad 382, but also lateral movement in at least one direction across the limb support pad 382. Thus, when placed as shown in FIG. 8, the limb support portion 594 may engage and support a desired part of the limb, such as an elbow. The restraint tabs 596 may be extended up and over the limb, such as the forearm, perhaps crossed, and then fastened, preferably removably, to the limb support pad 382. If desired, at least one of the first embodiment of limb stabilizing strap 488 may be utilized in conjunction with the second embodiment 590 to provide greater support of a limb against the pad 382.

FIG. 10 and FIG. 11 show alternate embodiments of the limb support 380. The support rods 384 are coupled to the limb support pad 382, preferably by a plurality of rod clamps 385, which may be provided with resilient liners. The limb support pad 382 is provided with strap engagement means, such as the hook side of a hook and loop fastener 383. Any stabilizing straps 488,590 used with the limb support tab and having the loop side of a hook and loop fastener may be removably coupled thereto. FIG. 11 also provides a method of coupling a wrench 387 to the limb support pad 382 for relatively easy access. The wrench 387 may be inserted into an extra rod clamp 385 coupled to the back side of the limb support pad 382. It may be preferable, however, to provide the hook and loop fastener 383 across the middle portion of the limb support pad 382, in which case the extra rod clamp would not be positioned as shown, if it is included at all.

In a method of use, an embodiment of a therapeutic support handle is clamped to a supporting structure, and a limb of a person is placed thereon. For instance, FIG. 12 shows the second embodiment 200 in use. A person 1 is positioned near a support structure, such as a table 7, and the device 200 is clamped thereto. The handle 150 is positioned in a desired position. The person 1 may then grasp the handle 150 with her hand 3, thereby supporting her elbow 5 in a desired position, preferably above the surface of the table 7.

The fourth embodiment 400 of a therapeutic support handle according to the present invention may be seen as being utilized in the following method in FIG. 13. A person 1 is positioned near a support structure, such as a table 7, and the device 400 is clamped thereto. The handle 150 is positioned in a desired position. The person 1 may then grasp the handle 150 with her hand 3, rest a desired portion of her limb, such as her forearm, against the limb support pad 382 and the limb may be secured to the device 400 by limb stabilizing straps 488. In this manner, positioning of the limb may be more readily maintained for desired purposes, and certain involuntary movements may be limited or constrained.

The fifth embodiment 500 of a therapeutic support handle according to the present invention may be seen as being utilized in the following method in FIG. 14. A person 1 is positioned near a support structure, such as a table 7, and the device 500 is clamped thereto. The handle 150 is positioned in a desired position. The person 1 may then grasp the handle 150 with her hand 3, rest a desired portion of her limb, such as. her forearm, against the limb support pad 382 and the limb may be secured to the device 500 by limb stabilizing straps 590. In this manner, positioning of the limb may be more readily maintained for desired purposes, and certain involuntary movements may be limited or constrained. The use of the second embodiment of a limb stabilizing strap 590 may be desirable where the person 1 has a weakened palmar grasp as the strap 590 aids in supporting the weight of the limb as well as limiting movement of the limb away from the device 500 that may be caused by flexor spasms. Additionally, straps according to the first embodiment of limb stabilizing straps 488 may be used to further aid in limiting the limb movement.

In addition to the use cases depicted, a plurality of devices, in any embodiment, may be used simultaneously by the same person, thus providing stabilization of more than one limb at the same time, e.g. both arms.

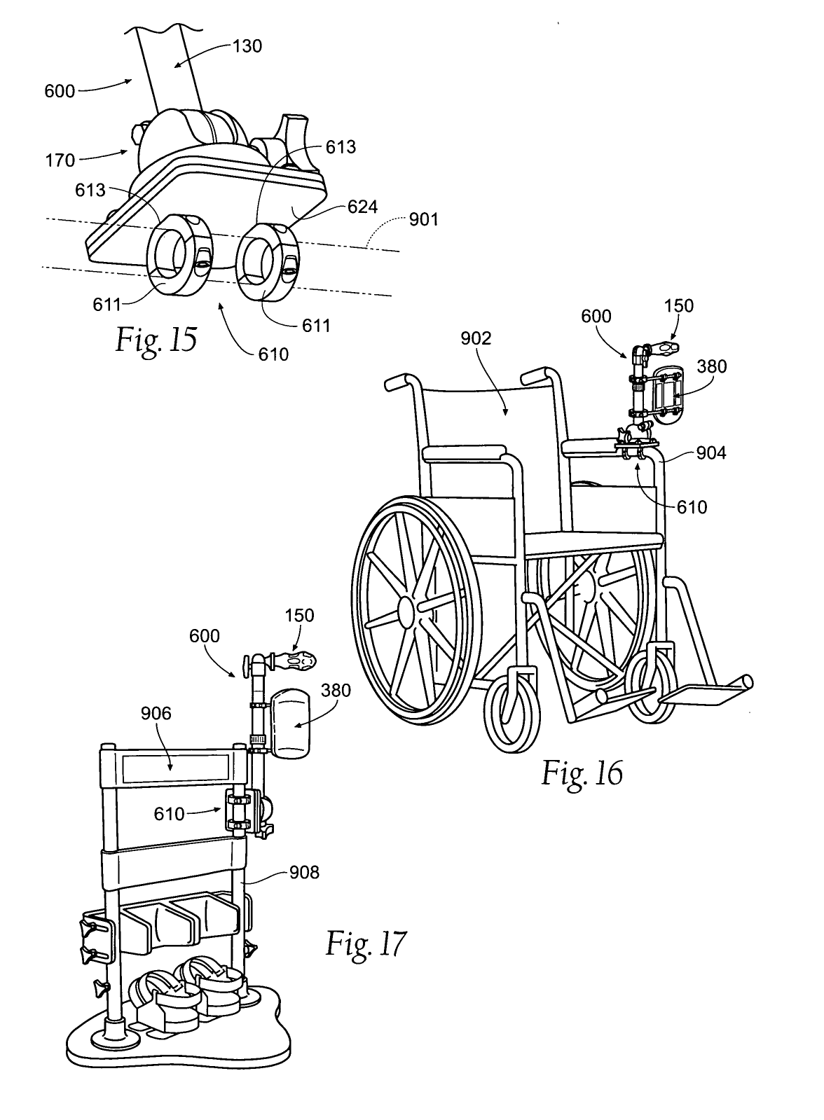

FIG. 15 shows a portion of a sixth embodiment 600 of a therapeutic support handle according to the present invention. This embodiment 600, like the first embodiment 100, includes a support platform 624 and a clamping mechanism 610. However, this clamping mechanism 610 is adapted to cooperate with a generally cylindrical support member 901, such as the support tubing 904 commonly found on wheelchairs 902, as shown in FIG. 16, or support tubing 908 commonly found on standing frames 906, as shown in FIG. 17. The clamping mechanism 610 generally comprises at least one, but preferably a plurality of shaft collars 611. Though generally preferably cylindrical in shape, the collars 611 may have modified portions, such as flattened portions 613, to interface with the support platform 624. The collars 611 may be bolted to the support platform 624. While single split shaft collars may be used, double split shaft collars 611 are preferred for ease of installation. The size of the shaft collars 611 to be used may be correlated to a predetermined diameter of cylindrical support member.

While any apparatus embodiment according to the present invention may be provided in any desirable size, certain ranges are preferable. For instance, the support shaft 130 is preferably provided in a length of about three inches to about twenty-four inches. If the length of the support shaft 130 is adjustable, it is preferably adjustable from about three inches to about twice as long as the first shaft member 132. More preferably, the length of the support shaft 130 is adjustable from about five inches to about ten inches. If an extension shaft 239 is used, such extension may be provided in any desirable length, including between about one inch to about twelve inches, and more preferably between about two inches to about four inches. Additionally, a preferred handle grip 152 may be provided in any desirable size, but preferred sizes range from about two inches in length from its support end 158 to its free end 156 to about five inches in length. The handle grip 152 may also have a diameter at its widest point of about one inch to about two inches.

Two or more components may be provided in a kit form, so as to allow construction of a therapeutic support handle according to the present invention. As FIG. 18 shows, in the illustrated embodiment, a kit 700 includes an interior tray 702 made from, e.g., die cut cardboard, plastic sheet, or thermo-formed plastic material. The tray 702 may include a plurality of component cavities 704, in which various components of a therapeutic support handle according to the present invention are disposed. A kit 700 according to the present invention presents its contents in a user-friendly orientation on the tray 702, to facilitate quick assembly of the handle using straightforward, intuitive steps. The kit 700 may include an inner wrap (not shown), which is peripherally sealed to itself or to the tray 702 by heat or the like, to enclose at least a part of the tray 702 from contact with the outside environment. The kit 700 may alternatively or additionally be wrapped in an outer wrap (not shown) such as a case formed of any desirable material for reuse such as leather, plastic, wood, or the like, and may be provided with a locking mechanism to secure the contents therein. Any kit according to the present invention may also include directions for assembly and/or use of the therapeutic handle. The directions may be provided as written, audio, and/or video instructions, for using the contents of the kit to carry out a desired procedure or method of therapy.

The comprehensive kit 700 shown in FIG. 18 includes the support shaft 130, the support base 170, and the handle head 154. Further included in the comprehensive kit 700 is a plurality of different sized handle grips 152a,152b,152c, an extension shaft 239, a first clamping mechanism 110, a second clamping mechanism 610, a limb support 380, and stabilizing straps 488,590. A first alternative kit may comprise the components to construct the first embodiment 100 described herein. A second alternative kit may comprise the components to construct the second embodiment 200 described herein. A third alternative kit may comprise the components to construct the third embodiment 300 described herein. A fourth alternative kit may comprise the components to construct the fourth embodiment 400 described herein. A fifth alternative kit may comprise the components to construct the fifth embodiment 500 described herein. A sixth alternative kit may comprise the components to construct the sixth embodiment 600 described herein. A seventh alternative kit may comprise the fifth alternative kit and at least one of the first embodiment of a limb stabilizing strap 488. An eighth alternative kit may comprise the sixth alternative kit and at least one of the first embodiment of a limb stabilizing strap 488. A ninth alternative kit may comprise the sixth alternative kit and at least one of the second embodiment of a limb stabilizing strap 590. A tenth alternative kit may comprise the eighth alternative kit and at least one of the second embodiment of a limb stabilizing strap 590. An eleventh alternative kit may comprise a support base 170, the support shaft 130, a handle 150, and any one or more of the following components: a support platform 124,624, a clamping mechanism 110,610, an extension shaft 239, a limb support 380, a first limb stabilizing strap 488, and a second limb stabilizing strap 590.

Further, regarding any combination of components to form any embodiment of a kit according to the present invention, certain components may be provided in coordinated colors. For instance, a majority of the components comprising the limb support 380, such as the support rods 384, the shaft collars 386, and the pad covering, may all be provided as the same color. Also, a first stabilizing strap 488 and/or a second stabilizing strap 590 may be provided in the same color as the majority of the components comprising the limb support 380. Additionally or alternatively, components may be offered in a variety of colors and provided in a selected color combination.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A support apparatus comprising:
a longitudinal shaft portion formed along a shaft axis and including a first shaft end and a second shaft end;
a support bracket operatively coupled to said first shaft end, said support bracket having a clamping mechanism; and
a handle having a grip coupled to a handle head, said grip being formed about a grip axis, said handle head operatively coupled to said second shaft end, wherein a relative positioning of said grip axis and said shaft axis is adjustable.

2. A support apparatus according to claim 1, wherein said grip axis is rotatable around said shaft axis.

3. A support apparatus according to claim 2, wherein said grip axis is positioned at an angle relative to said shaft axis, wherein said angle is greater than or equal to zero degrees and said angle is less than or equal to ninety degrees.

4. A support apparatus according to claim 1, wherein said grip axis is positioned at an angle relative to said shaft axis, wherein said angle is greater than or equal to zero degrees and said angle is less than or equal to ninety degrees.

5. A support apparatus according to claim 1, said grip being removably coupled to said handle head.

6. A support apparatus according to claim 5, said grip having a threaded aperture which is adapted to engage with a threaded stud extending from said handle head.

7. A support apparatus according to claim 1, said handle head having a threaded aperture which is adapted to engage with a threaded stud extending from said longitudinal shaft second shaft end.

8. A support apparatus according to claim 1, said longitudinal shaft comprising:
a first shaft member including said first shaft end; and
a second shaft member disposed at least partially coaxially and in a telescoping arrangement with said first shaft member, said second shaft member including said second shaft end.

9. A support apparatus according to claim 8, said first shaft member comprising a hollow tube, wherein at least a portion of said first shaft member is disposed circumferentially around at least a portion of said second shaft member.

10. A support apparatus according to claim 9, said longitudinal shaft portion further including a threaded adjustment collar, said adjustment collar being movable to a first position which allows said second shaft member to slide within said first shaft member and movable to a second position which substantially prevents said second shaft member from sliding within said first shaft member.

11. A support apparatus according to claim 10 said longitudinal shaft portion further including a discrete length locking mechanism comprising:
an outer throughbore diametrically formed through said first shaft member, said outer throughbore formed along an outer throughbore axis;
a first inner throughbore diametrically formed through said second shaft member, said first inner throughbore formed along an inner throughbore axis; and
a pin adapted to be inserted into at least a portion of said outer throughbore and at least a portion of said first inner throughbore.

12. A support apparatus according to claim 11, wherein said pin is coupled to said support bracket.

13. A support apparatus according to claim 9 said longitudinal shaft portion further including a discrete length locking mechanism comprising:
an outer throughbore diametrically formed through said first shaft member, said outer throughbore formed along an outer throughbore axis;
a first inner throughbore diametrically formed through said second shaft member, said first inner throughbore formed along an inner throughbore axis; and
a pin adapted to be inserted into at least a portion of said outer throughbore and at least a portion of said first inner throughbore.

14. A support apparatus according to claim 13, wherein said pin is coupled to said support bracket.

15. A support apparatus according to claim 8 further comprising:
a limb support mechanism coupled to and extending radially from said longitudinal shaft portion, said limb support mechanism being spaced from said handle grip.

16. A support apparatus according to claim 15, said limb support mechanism comprising:
a support pad including a formed plate and a soft resilient pad attached to said plate;
a first support rod and a second support rod, both of said support rods coupled to said formed plate,
a first shaft collar adapted to releasably secure said first support rod to said first shaft member; and
a second shaft collar adapted to releasably secure said second support rod to said second shaft member.

17. A support apparatus according to claim 16, said limb support mechanism further comprising a strap, at least a portion of said strap being selectively detachably coupled to said formed plate.

18. A support apparatus according to claim 1 further comprising:
a limb support mechanism coupled to and extending radially from said longitudinal shaft portion, said limb support mechanism being spaced from said handle grip.

19. A support apparatus according to claim 18, said limb support mechanism comprising:
a support pad including a formed plate and a soft resilient pad attached to said plate;
a first support rod and a second support rod, both of said support rods coupled to said formed plate,
a first shaft collar adapted to releasably secure said first support rod to said longitudinal shaft portion; and
a second shaft collar adapted to releasably secure said second support rod to said longitudinal shaft portion.

20. A support apparatus according to claim 19, said limb support mechanism further comprising a strap, at least a portion of said strap being selectively attached and detached from said formed plate.

21. A support apparatus according to claim 1, wherein said longitudinal shaft portion is translatable through at least a first substantially hemispherical range of motion with respect to said clamping mechanism and said handle grip is translatable through at least a second substantially hemispherical range of motion with respect to said longitudinal shaft portion.
